(19) United States
(12) Patent Application Publication
(10) Pub. No.: US 2022/0118626 A1
(43) Pub. Date: Apr. 21, 2022

(54) PROVIDING DISPOSITION-DRIVEN RESPONSES TO STIMULI WITH AN ARTIFICIAL INTELLIGENCE-BASED SYSTEM

(71) Applicant: Nam Kim, Duluth, GA (US)

(72) Inventor: Nam Kim, Duluth, GA (US)

(21) Appl. No.: 17/071,350

(22) Filed: Oct. 15, 2020

(51) Int. Cl. B25J 11/00; G06N 3/00; B06B 1/10

(52) U.S. Cl. CPC B25J 11/001; B06B 1/10; G06N 3/008

(57) ABSTRACT

An artificial intelligence-based computer-implemented method and system is provided for performing an action with a machine. Input is received from one or more sensors. The input is used to determine a stimulus, which is used with a waveform to select a set of actions to perform. A mood of the machine is determined from a second waveform generated by a mood mechanism. The mood is used to select an action from the subset of actions. The mood may activate one or more reaction mechanisms to provide a physiological response. The machine then initiates the action.

### BACKGROUND

Automated machines are abundant in society today. Machines are capable of performing virtually endless types of actions according to a pre-programmed set of instructions. Robots are utilized in commercial and industrial environments to perform all types of tasks, all of which are pre-programmed and predictable. These industrial robot implementations are usually limited to repetitive tasks on an assembly line, performing actions that could be performed by humans, but without any emotion, thought, judgement, or variation from the programmed task. Robots are also created for entertainment purposes. These robots are capable of performing numerous types of tasks, including moving around an environment, speaking and responding to questions and instructions, and providing limited interaction with the environment and individuals within the environment. This interaction is typically limited to providing a programmed response to one or more programmed triggers within the environment, such as to a verbal question or instruction.

Although it has long been desirable to create a robot that closely simulates a human, conventional robots fail to accurately emulate human personalities and moods. A human's general personality and their specific mood at any given time are features that makes them unique, and features that drive their thought, verbal expression, and actions at that time. A response to a given stimuli may vary significantly for an individual based on that individual's personality and mood at the time, and additionally based on any number and type of factors at the moment the stimuli was experienced. Any “personality” expressed by a robot is pre-programmed by its software developers. Conventional robots and machines are not capable of mimicking aspects of human decision making in large part because traditional machines have no emotions or accurate simulation of emotion. Various embodiments of the present disclosure recognize and address the foregoing considerations, and others, of prior art machines.

### SUMMARY OF VARIOUS EMBODIMENTS

It should be appreciated that this Summary is provided to introduce a selection of concepts in a simplified form that are further described below in the Detailed Description. This Summary is not intended to be used to limit the scope of the claimed subject matter.

A computer-implemented artificial intelligence method for performing an action with a machine is provided. According to one aspect, the method includes receiving a first sensory input from one or more sensors of the machine. A stimulus is determined from the first sensory input. A subset of actions is selected according to the stimulus and at least one characteristic of a first waveform created by a personality waveform generator. A mood of the machine is determined from a characteristic of a second waveform generated by a mood mechanism. An action is selected from the subset of actions according to the mood of the machine, and the action is initiated.

According to another aspect, a computer-implemented artificial intelligence method includes receiving a first sensory input from one or more sensors of the machine. At least one characteristic of a first waveform is determined. A set of actions is selected according to the sensory input and the at least one characteristic of the first waveform. A characteristic of a mechanical waveform generated by a vibration generator is determined. A reaction mechanism corresponding to the characteristic of the mechanical waveform is activated. An action is selected from a first subset of the set of actions according to the characteristics of the mechanical waveform and to the reaction mechanism, and the action is initiated.

According to yet another aspect, an artificial intelligence system is provided for performing an action with a machine. The system includes one or more sensors, memory, a processor, a waveform generator, a mood mechanism, and at least one computer module. The waveform generator is operative to generate a light or audio waveform. The mood mechanism is operative to generate a mechanical waveform. The at least one computer module is stored in the memory, coupled to the at least one processor, and is operative to receive a sensory input from the one or more sensors, determine at least one characteristic of the light or audio waveform, select a set of actions according to the sensory input and the at least one characteristic of the light or audio waveform, determine a characteristic of the mechanical waveform generated by the mood mechanism, activate a reaction mechanism corresponding to the characteristic of the mechanical waveform, select an action from the first subset of the set of actions according to the characteristic of the mechanical waveform and to the reaction mechanism, and initiate the action.

The features, functions, and advantages that have been discussed can be achieved independently in various embodiments of the present disclosure or may be combined in yet other embodiments, further details of which can be seen with reference to the following description and drawings.

### BRIEF DESCRIPTION OF THE DRAWINGS

Having described various embodiments in general terms, reference will now be made to the accompanying drawings, which are not necessarily drawn to scale, and wherein:

FIG. 1 is a block diagram of a disposition-driven machine that includes the system.

FIG. 2 is a block diagram of the computer of the disposition-driven machine of FIG. 1.

FIG. 3 depicts a flowchart that generally illustrates a routine for responding to stimuli according to a particular embodiment.

FIG. 4 depicts a flowchart that generally illustrates a consciousness module according to a particular embodiment.

FIG. 5 depicts a flowchart that generally illustrates a sub-consciousness module according to a particular embodiment.

FIG. 6 depicts exemplary simulated personality waveforms.

FIG. 7 depicts exemplary simulated personality waveform patterns and/or simulated mood waveform patterns.

FIG. 8 depicts an exemplary simulated personality waveform at two different times.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As discussed above, conventional robots or machines are often designed to mimic human behavior. However, this behavior is limited to pre-programmed responses and actions that are consistent throughout the functional “lifespan” of the robot. For example, a robot may be programmed to perform an action based on a given instruction, such as an instruction to “walk forward” would elicit a response of moving forward. The robot will perform the exact same action based on the same instruction every time. These are programmed “stimulus A=response B” types of actions. Conventional robots and machines do not act or respond differently according to a mood or personality. In contrast, a disposition-driven machine disclosed herein performs actions and responds to stimuli according to a particular personality and/or mood of the machine. For the purpose of this disclosure, the term “disposition-driven machine” will be used to describe a robot, apparatus, device, computer, machine, or system having the characteristics and capabilities described herein. Specifically, a disposition-driven machine, as described herein, performs actions that are not limited to programmed “stimulus A=response B” types of actions performed by conventional machines. Rather, a disposition-driven machine described herein performs actions and responses to stimuli that are based at least in part on a disposition of the machine at the time of the action or particular stimulus. The disposition may be based on a personality and/or a mood associated with the machine.

Humans are inherently different in not only how each individual looks, but also with respect to how each individual acts or responds to the environment around them. For example, different individuals will respond differently to the exact same stimulus. One person might walk outside to a beautiful day and immediately react with a smile and even pause to comment on the beauty or pleasantness of the day. Another person might walk outside to the same beautiful day and react negatively based on being in a bad mood for having to work or do something he or she does not want to do on such a beautiful day. A person's actions are often driven by his or her underlying personality. A generally happy, positive person may take actions and react to stimuli in a manner that reflects positivity, helpfulness, and cheerfulness. A generally grumpy person may take actions and react to stimuli in a manner that reflects negativity and self-centeredness.

Not only do different people react differently to stimuli based on their individual personalities, a single person may react differently to the same stimulus at different times based on his or her mood at the given time. Every individual experiences different moods at different times. The times may correspond to a time of day, wherein someone may be generally grumpy or introverted in the mornings, while being generally happy and extroverted in the afternoon or evening. Moods may differ based on the day of the week, wherein someone may be more apt to be in a bad mood on a Monday with the work week ahead of them, while experiencing an improved mood at the end of the week with the weekend approaching. Moods often differ with the seasons of the year. Some individuals experience depression during the winter or during a rainy season, while finding happiness in warmer and sunnier months.

Another distinguishing feature between conventional robots and humans relates to a physiological response to stimuli according to a given mood. Humans experience physiological reactions to their current emotional state. For example, fear, anger, stress, and anxiety may create an increased heart rate, changes in skin conductance, an increase in skin temperature, sweating, an increased breathing rate, and/or cutaneous blood flow causing a skin color change (e.g., blushing). Happiness, sadness, and other emotions may similarly create physiological changes to the human body.

In contrast, conventional robots or machines are only capable of simulating a human's emotional state through pre-programmed changes in one or more facial features. Conventional robots or machines are programmed to respond according to “stimulus A=response B” programming. For example, a toy or entertainment-focused robot may be programmed with instructions to manipulate servos that raise or lower the corners of the robot's mouth to smile or frown in response to a specific stimulus. Other than attempting to visually emulate an emotional state through the creation of a facial expression, conventional robots are incapable of replicating the physiological responses that humans experience, which severely restricts the ability of conventional robots to mimic human emotion.

According to the various embodiments described herein, a disposition-driven machine has a reaction mechanism that provides a physiological change to one or more physical characteristics of the machine based on a mood associated with the machine and/or in reaction to a stimulus according to the mood. For the purposes of this disclosure, the physiological changes to the one or more physical characteristics of the disposition-driven machine exclude movement to one or more external features of the machine. For example, the physiological changes encompassed by the disclosure provided herein would exclude two or three-dimensional movement of all or a portion of one or more simulated eyebrows, eyes, nose, mouth, limbs, or any physical external component of the machine. In this manner, the physiological changes or reaction mechanism of the disposition-driven machine described herein provides significantly more than a manipulation of a simulated facial feature to communicate a mood such as happiness or sadness expressed as a smile or frown.

Rather, the physiological changes or reaction mechanism of the disposition-driven machine described herein provides for physiological changes similar to those experienced by humans that may be triggered by feelings. Feelings of happiness, sadness, fear, anger, stress, anxiety, shock, love, and others that are experienced by a person in response to a stimuli may then trigger the corresponding physiological change, such as a change in heart rate, breathing, body temperature, sweating, or blushing. According to the embodiments described below, a disposition-driven machine's reaction mechanism or physiological response may be triggered or activated at least in part by a vibration or other waveform that defines an underlying mood of the machine. Further, the actions taken by the disposition-driven machine may be triggered by or selected using at least in part the chosen reaction mechanism. The disposition-driven machine described herein is referred to as based on artificial intelligence since, according to various embodiments, the system is configured to receive input, translate that input into human language thought, and using that thought, coupled with a simulated representation of an underlying personality and an instantaneous mood, act upon that input and corresponding thought.

Various embodiments will now be described more fully hereinafter with reference to the accompanying drawings, in which various relevant embodiments are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Exemplary System Architecture

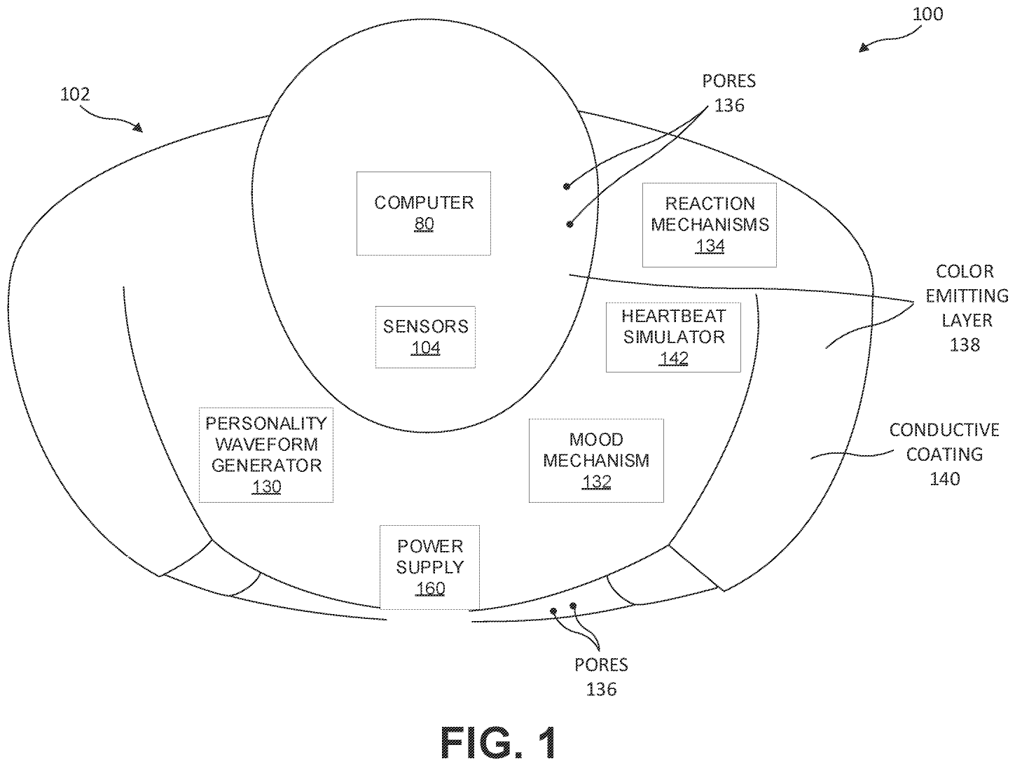

FIG. 1 shows a block diagram of a disposition-driven machine 100 including a disposition-driven system 102 according to a preferred embodiment of the present invention. For the purposes of this disclosure, the disposition-driven machine 100 may alternatively be referred to as a “robot” or “machine” having “artificial intelligence” based systems or processes. The disposition-driven system 102 includes all components described herein for executing the features and capabilities described below. As may be understood from FIG. 1, the disposition-driven system 102 includes a number of sensors 104, at least one computer 80, a personality waveform generator 130, a mood mechanism 132, a number of reaction mechanisms 134, and at least one power supply 160.

The sensors 104 may include any type of sensor operative to detect external stimuli and provide a corresponding signal or sensor data to the processor of the disposition-driven system 102 for processing. Example sensors 104 include, but are not limited to, one or more cameras 106, microphones 108, light sensors 110, temperature sensors 112, moisture sensors 114, touch sensors 116, taste sensors 118, olfaction sensors 120, and/or motion sensors 122. There may be any number of these or other sensors 104 without departing from the scope of this disclosure.

The cameras 106 are adapted to provide the disposition-driven system 102 with feedback relating to visual stimuli. The cameras 106 may capture still images or video. The cameras 106 may stream and/or record visual information to be used by components of the disposition-driven system 102 (e.g., an image recognition module) or to be stored for later use. The microphones 108 are adapted to detect and receive audible stimuli. The light sensors 110 are adapted to detect light, and in combination with the other applicable components of the disposition-driven system 102, to determine an intensity and/or color of the light, as well as any other type of characteristics of the waveform such as wavelength or amplitude. Temperature sensors 112 are used to determine an ambient temperature and changes in temperature. Moisture sensors 114 may be used to detect a relative humidity level or the presence of rain or water.

Touch sensors 116 may include any type of sensor operative to detect contact with or from another object or person. Known sensors used to detect vibration, impact, or electrical capacitance or resistance may be utilized to detect when the disposition-driven machine 100 has come into contact with another object or person. Taste sensors 118 may include any type of sensors operative to detect a type of material being “tasted” by the disposition-driven system 102. As an example, different foods include different types of chemical compounds that are capable of being detected and identified by chemical sensors. Electrostatic and hydrophobic interactions between the food and the sensor allow for identification of bitterness, saltiness, sweetness, sourness, and other tastes to a degree that allows for food identification. Similarly, olfaction sensors 120 are known to detect and identify odors or gases based on their chemical composition. Motion sensors 122 may include gyros, accelerometers, GPS components, or any other type of sensors that detect and measure motion of the disposition-driven machine 100 or of objects or persons interacting with the disposition-driven machine 100.

Feedback from the sensors 104 is referred to herein as external stimuli. External stimuli includes, but is not limited to, sounds, sights (e.g., objects, people, scenes, color, light, etc), motion, impacts or contact with objects or people, taste of food, odors, and anything else that is detectable by the disposition-driven system 102. In response to receiving external stimuli from the various sensors 104, the disposition-driven system 102 is adapted to determine a response to the stimuli. The response may include any type of action or inaction that is triggered by or determined from the stimuli. As will be described in greater detail below, the response may include translating the external stimuli into human language, similar to the human thought process. A visual identification of an apple may result in an actual translation within the disposition-driven system 102 to “there is an apple,” which may result in further thought and/or action. In this case, the human language, “there is an apple” may become an internal stimulus, which results in further action. Receiving external stimuli may further result in an action being taken, with or without translation into human language. Both external and internal stimuli triggers action, which can be a physical action and/or further “thought” that includes additional human language statements or questions.

According to one embodiment, the external or internal stimulus may trigger an internal video or image being retrieved and played by the disposition-driven system 102. The visuals may be displayed an internal or an external display device 64. The images or video selected for display are associated with the stimulus in the look-up table 280 in storage, and may be selected based on the simulated personality and/or mood as described herein. The images or video may be pre-programmed “stock” images or video, or may be recorded and stored by the disposition-driven system 102 such that the images or video are based on past experiences. The disposition-driven system 102 may record the surrounding environment whenever associations are made, such as whenever a response or action is performed based on an extreme mood. For example, a video clip may be stored and tagged for retrieval during a later search corresponding to a reaction of a bystander when the disposition-driven machine 100 performed a benevolent action, perhaps during a period when the simulated mood was very high. This clip may be retrieved in similar future circumstances, allowing the disposition-driven system 102 to predict the reaction of bystanders at the future time. In this scenario, the disposition-driven machine 100 has thought of a similar circumstance, visualized it, and learned from it to predict the result of a similar action to be taken. This behavior emulates human behavior in a manner that has not been conventionally done.

It should be appreciated that the images or video may trigger further action, either physical or mental, by the disposition-driven system 102. In this manner, the disposition-driven machine 100 is simulating “thought” with visual images, just as a person can visualize images and video within their minds during conscious thought or while dreaming. Responses to stimuli are determined according to a simulated personality and/or a simulated mood of the disposition-driven system 102, just as humans act or think according to a base personality, as well as to a mood of the person at the time of the stimuli. According to various embodiments described herein, the simulated personality of the disposition-driven system 102 is defined by one or more characteristics of at least one waveform created by a personality waveform generator 130 at a time or period of time encompassing the stimuli. The waveform may be any type of waveform, including light waves and sound waves. According to one embodiment, the personality waveform generator 130 includes a light source 92 that creates light waves that define or affect the responses to stimuli that the disposition-driven system 102 receives. According to another embodiment, the personality waveform generator 130 includes an audio source 94 that creates sound waves that define or affect the responses to stimuli that the disposition-driven system 102 receives. The personality waveform generator 130 will be described in greater detail below.

According to further embodiments described below, the disposition-driven system 102 responds to stimuli according to not only a simulated personality, but also according to a simulated mood of feeling at the time of the stimuli. Just as humans may respond differently to any given situation depending on if they are happy, sad, angry, etc, the disposition-driven system 102 described herein may do the same. Feelings or moods may be simulated using a mood mechanism 132, such as an internal vibration system or other waveform generator. As will be described in greater detail below, the mood mechanism 132 generates vibrations at varying frequencies. The frequency of vibration is associated with a mood that drives the selection of a response to any given stimulus.

As mentioned above, humans experience physiological responses to various external and internal stimuli. For example, people often sweat when anxious, blush when they become the center of attention or when receiving affection, turn red when angry, or feel a sense of “electricity” running through their body when afraid or surprised. According to embodiments discussed herein, the disposition-driven system 102 includes one or more reaction mechanisms 134 configured to invoke a physiological response within or on the disposition-driven machine 100. Reaction mechanisms 134 include, but are not limited to, pores 136, color emitting layer 138, conductive coating 140, and heartbeat simulation mechanism 142. The reaction mechanisms 134 may be activated separately or in combination in response to determining a mood of the machine. For example, when the mood is determined from an amplitude or frequency of the vibration or other waveform created by the mood mechanism 132 to be surprise or fear, preprogrammed instructions stored within the machine may be executed to activate the reaction mechanisms 134 corresponding to sweating (pores 136), turning pale or another appropriate color (color emitting layer 138), and increasing a simulated heart rate (heartbeat simulation mechanism 142).

Pores 136 may include any number of apertures positioned within a surface layer of the disposition-driven machine 100. Each aperture may be coupled to one or more reservoirs via one or more channels or conduits. In this manner, the disposition-driven system 102 may respond to an internal or external stimuli by simulating sweating by expelling liquid from the one or more reservoirs through the pores. Implementation of expelling liquid through the pores may occur via any known manner of transferring liquid from a reservoir to one or more pores 136. For example, the reaction mechanism 134 may include one or more pumps operative to pump liquid from the reservoir through the pores. Alternatively, the reservoir may be pressurized with compressed air or gas to displace the liquid through the conduits and through the corresponding pores 136. The reservoir may alternatively be compressible such that expansion of an internal diaphragm within the disposition-driven machine 100 compresses the reservoir and expels liquid through the pores 136. It should be appreciated that the sweating system that includes the pores 136, reservoir, and corresponding conduits may be configured to expel very small quantities of liquid, or even to bring the liquid to the surface of the disposition-driven machine 100 at an exit of the pores, so as to provide moisture that simulates human sweating.

The color emitting layer 138 may include any type of material or display positioned on the surface, or under a translucent or transparent layer, of the disposition-driven machine 100 that may be selectively altered to change a visible color of at least a portion of the disposition-driven machine 100. For example, the disposition-driven machine 100 may include thermochromic material that may be selectively altered to change color in response to a temperature change, a photochromic material that may be selectively altered to change color in response to a light change, an electrochromic material that may be selectively altered to change color in response to an application of electrical potential or voltage, and/or an LCD or other display that may be utilized to selectively alter the color of the simulated skin or subcutaneous layer under the simulated skin. In this manner, the disposition-driven machine's face, neck, arms, or any other desirable portion of the machine may simulate blushing with attention or shyness, reddening with anger, and/or becoming pale with simulated shock or sickness.

The reaction mechanisms 134 may additionally include a conductive coating 140 that covers at least a portion of the disposition-driven machine 100. According to one embodiment, the conductive coating 140 provides a capacitive sensor that detects the change in electrical impulse when contacted by a human finger or similar device. This provides an input for external stimuli associated with contact with a human finger or other object that alters the electrical characteristics of the coating at the point of contact. Specifically, the disposition-driven machine 100 is able to detect and interpret contact via the conductive coating 140. According to an alternative embodiment, the conductive coating provides for the transmission of electricity throughout the coating. In doing so, the disposition-driven machine 100 may react to stimuli by activating a power source and completing a circuit within the coating to increase the temperature of the coating and simulate an increase in skin temperature.

The conductive coating 140 may additionally or alternatively be configured to provide an electrical circuit that when touched, provides a minor, non-harmful electrical shock or stimulation. In this manner, the disposition-driven machine 100 may react to stimuli that might invoke anger in a human, or react to a stimulus when the disposition-driven machine 100 is experiencing a “bad mood,” to provide an electrical shock or stimulation if touched.

The disposition-driven machine 100 may include a reaction mechanism 134 implemented as a heartbeat simulation mechanism 142. Conventional robots and machines do not have a heartbeat, as no living heart is required to pump blood through vital components of the machine. However, human hearts and corresponding heartbeats provide physiological changes in response to stimuli. Surprise, anger, fear, elation, and any intense emotions cause a human heart to increase the speed at which it pumps. This increased heartbeat can be felt internally by the human, as well as felt externally when a hand is placed over the person's heart or on an artery. Heartbeats can even be seen by others as movement of the chest and/or in the arteries of a person's neck or wrist. According to embodiments described herein, a heartbeat simulation mechanism 142 creates an artificial heartbeat that may be modulated according to mood and stimuli. The heartbeat simulation mechanism 142 may include a mechanical or electromechanical device that drives one or more pistons or cams to drive one component into another to create a simulated heartbeat that may be heard, felt, and/or seen. For example, a rotating shaft having two cams that translate rotating motion into linear motion to drive cam followers into a component to create the “beat.” This rotation and corresponding heartbeat may be controlled by the disposition-driven system 102, which sends control signals to a motor driving the heartbeat simulation mechanism 142. The intensity or frequency of the heartbeat may be controlled in response to external or internal stimuli, based on mood as described in greater detail below.

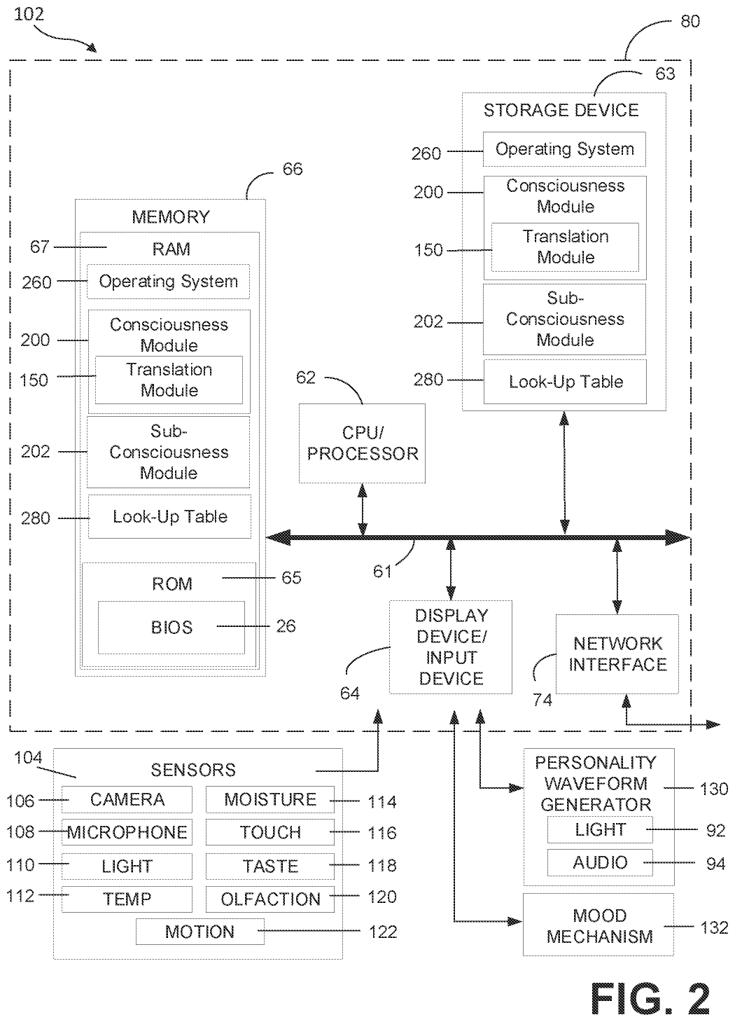

FIG. 2 shows a block diagram of an exemplary embodiment of the disposition-driven system 102 of FIG. 1. The disposition-driven system 102 includes a computer 80, having a CPU or processor 62 that communicates with other elements within the disposition-driven system 102 via a system interface or bus 61. Also included in the disposition-driven system 102 is a display device/input device 64 for receiving and displaying data. The display device/input device 64 may be, for example, a keyboard, voice recognition, or pointing device that is used in combination with a monitor. In other embodiments, the display device 64 may alternatively or additionally include an internal monitor that is not visible from a perspective outside of the disposition-driven machine 100. In this embodiment, the internal monitor may be used to display video and/or images for an internal camera to capture and provide to the disposition-driven system 102 for interpretation. This internal video and image display and viewing is similar to the visualization that occurs in a human mind during thought and even dreaming.

The disposition-driven system 102 further includes memory 66, which preferably includes both read only memory (ROM) 65 and random access memory (RAM) 67. The server's ROM 65 is used to start a basic input/output system 26 (BIOS) that contains the basic routines that help to transfer information between elements within the disposition-driven system 102. As seen in FIG. 2, the disposition-driven system 102 also includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the disposition-driven system 102. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices 63 and within RAM 67. Such program modules include an operating module 260, a consciousness module 200, a translation module 150, a sub-consciousness module 202, and a look-up table 280. The consciousness module 200 and sub-consciousness module 202 control certain aspects of the operation of the disposition-driven system 102, as is described in more detail below, with the assistance of the CPU 62 and an operating module 260. The translation module 150 translates stimuli received by the sensors 104 into a human language to create a human language stimuli or internal stimuli as described below. The translation module 150 may operate as part of the consciousness module 200 of may be executed independently by the disposition-driven system 102 or as part of, or in conjunction with, any other module or system associated with the disposition-driven system 102. The look-up table 280 includes data associating any number and type of external stimuli received from the various sensors 104 or internal stimuli with potential responses to those stimuli. For example, when the disposition-driven system 102 encounters a loud noise, potential responses stored with the look-up table 280 may include “run,” “collect visual data (i.e., look towards the source of the sound),” “investigate noise by travelling to the source for data collection,” “ask a nearby person about the noise,” or many other possible responses. According to one embodiment, the response chosen is dependent upon characteristics of the waveform generated by the personality waveform generator 130 at the time of the noise, as well as characteristics of a vibration or other waveform generated by the mood mechanism 132. According to another embodiment, the response may be chosen according to the characteristics of the waveform generated by the personality waveform generator 130, and then further filtered according to the reaction mechanism triggered by the mood mechanism 132.

As discussed above, the disposition-driven system 102 communicates with any number of sensors 104 for receiving input corresponding to stimuli that may be used for response purposes, such as to create an action or a “thought.” As will be described in detail below, the conscious or sub-conscious response may be selected at least in part according to a simulated personality of the machine, as defined by the personality waveform generator 130 (e.g., using a light source 92 or audio source 94), as well as by a simulated mood of the machine, as defined by the mood mechanism 132 at the time of the stimuli.

Also located within the disposition-driven system 102 is a network interface 74 for interfacing and communicating with other elements of a computer network. It will be appreciated by one of ordinary skill in the art that one or more of the disposition-driven system 102 components may be located geographically remotely from other disposition-driven system 102 components. Furthermore, one or more of the components may be combined, and additional components performing functions described herein may be included in the disposition-driven system 102.

Personality Waveform Generator—Defining Personality

As mentioned above, the disposition-driven system 102 includes or utilizes a personality waveform generator 130 to define the boundaries of a simulated personality of the disposition-driven system 102. To understand the functionality of the personality waveform generator 130, a discussion of human personalities and moods will be provided.

Humans have unique personalities that define their overall thoughts and actions. For example, introverted people tend to be shy, avoid groups of people and situations that would put them at the center of attention. For these reasons, when faced with a choice to attend a large social gathering or stay at home and watch a movie alone or with a close friend, the introverted person would likely choose to stay at home. Similarly, some people are generally happy, sad, angry, polite, rude, etc. Personalities may or may not change as the person ages or experiences new environments or situations in life. Children are more apt to make rash, unreasonable decisions for instant satisfaction. Adults may be more apt to think about the repercussions of a decision before acting, resulting in a more reasoned response. So while an introverted personality may generally rule a person's decisions, the same choices or decisions over the course of the person's life may change as the person's age and experience changes.

Conventional robots do not have personalities similar to human personalities. Any predisposition to shyness or aggression or any other category of actions that could be equated to personality is merely programmed into the system as a simple or complex set of “if-then” algorithms. However, according to embodiments described herein, the disposition-driven system 102 is provided with a personality waveform generator 130 that defines the general personality of the machine. The simulated personality is defined by the anatomy of a waveform.

For example, a waveform having a high frequency with very large amplitudes may define a simulated personality that is substantially more aggressive or even “hyperactive” as compared to a simulated personality defined by a waveform having a low frequency and relatively low amplitudes. A low frequency defines a smooth and calm underlying attitude. The low frequency might represent an adult that is wise and generally peaceful and altruistic in nature, someone who thinks about the consequences of their actions and makes reasoned responses that take into consideration the repercussions of their actions on others.

In contrast, a high frequency waveform characteristic might define an active or hyperactive personality, perhaps representing a child that is somewhat self-centered and only concerned with the immediate benefits of an action, without regard to the effect of the action on others. According to various embodiments, the subset of responses to any particular stimuli are selected according to the waveform using characteristics of the waveform such as frequency or wavelength, amplitude, or a combination thereof. For example, upon receiving stimuli from the sensors 104 indicating laughter is nearby, the disposition-driven system 102 may determine that the waveform characteristics include a high frequency and a high amplitude. As a result, a subset of responses from the look-up table 280 are selected that correspond to different manners of deviating from a current task to explore the laughter and fun. If the waveform characteristics included a lower frequency and amplitude, a different subset of responses may be selected from the look-up table that include brief or no exploration while continuing the task at hand. It should be appreciated that these and all examples discussed herein are merely illustrative and not meant to be limiting. One with skill in the art would appreciate defining any characteristics of any type of waveform with personality characteristics and associated responses or subsets of responses accordingly.

Utilizing Light and its Shape to Create Mental Patterns

Light has an infinite spectrum of colors (wavelengths) and a continuous flow. Light waves can have narrow maximum variations (i.e., substantially small amplitude) to express a calm, passive, and feminine nature. Alternatively, light waves can have wide variations (i.e., substantially large amplitude) and express aggressive, active, and masculine nature. The electromagnetic spectrum illustrates the changing wavelength, frequency, and amplitude of a waveform as the wave transforms from a radio wave having an extremely long wavelength on the order of 10³ m with low frequency on the order of 10⁴ Hz, to a gamma wave with an extremely short wavelength on the order of 10⁻¹² m and high frequency of 10²⁰ Hz. The visible light spectrum is what humans see as colors, with different colors having different wavelengths and frequencies. According to various embodiments, the personality waveform generator 130 generates light and corresponding colors to define a simulated personality. The light wave characteristics associated with red may represent a first personality characteristic, while light wave characteristics associated with violet represents a second personality characteristic. It should be appreciated that any colors or even wave types (e.g., infrared, ultraviolet, or any other type of light or wave along the electromagnetic spectrum) may be used to define a simulated personality. According to one embodiment, the personality waveform generator 130 creates waveforms having wavelengths between about 10⁻⁵ m and 10⁻⁸ m and frequencies between about 10¹² Hz and 10¹⁶ Hz. According to yet another embodiment, the personality waveform generator 130 creates waveforms having wavelengths between about 10⁻⁶ m and 10⁻⁷ m and frequencies between about 10¹³ Hz and 10¹⁵ Hz.

The personality waveform generator 130 may be internal to the disposition-driven system 102 or external. For example, the personality waveform generator 130 may include a light source 92 having one or more LEDs mounted within any portion of the disposition-driven system 102. The one or more LEDs may be programmed to illuminate with a particular color and intensity to create any desired light wave having any desired waveform characteristics according to a simulated personality profile. Light wave detection and measurement components within the disposition-driven system 102 are used to determine the characteristics of the light wave representing the simulated personality at the time of a corresponding stimuli in order to determine a proper response or subset of potential responses.

Different embodiments may utilize different waveform generation procedures for creating a desired light wave. A straightforward implementation includes providing a single color corresponding to specific simulated personality characteristics all or a majority of the time. With multiple disposition-driven systems 102, some systems may be programmed with certain colors to represent first simulated personalities, while other systems are programmed with other colors to represent different simulated personalities.

According to other embodiments, the disposition-driven system 102 includes a personality waveform generator 130 that alters the color or waveform characteristics according to any desired criteria. For example, a disposition-driven system 102 may have a personality waveform generator 130 that emits a light wave having a color corresponding to a calm, peaceful demeanor or personality at certain times of the day, days of the week, or seasons of the year, while altering the color at other times.

The personality waveform generator 130 may alternatively be external to the disposition-driven system 102. Specifically, light wave detection and measurement components within the disposition-driven system 102 may be used to determine the characteristics of the light wave created in the ambient environment. In these embodiments, the simulated personality of the machine may be dependent upon the light in its environment. Disposition-driven machines or machines that operate in low light or specific colors and characteristics corresponding to light from different light sources 92 may have varying personalities that correlate with those environments.

It should be appreciated that although the personality waveform generator 130 has been described with examples utilizing light waves created by a light source 92, the embodiments may alternatively utilize sound waves created by one or more audio sources 94. In these embodiments, the disposition-driven system 102 may utilize speakers internal or external to the machine. Alternatively, the disposition-driven system 102 may “hear” the waveform by analyzing an electrical signal created by the audio source 94 that would ordinarily be connected to a speaker to transform the electrical signal into an audible sound. One way to think of this would be as if the cord to the speaker were cut so that the signal is received and utilized to interpret the sound that the speaker would create if the speaker were installed. As with the external light source example above, embodiments may utilize external sounds within the ambient environment to define the simulated personality of the disposition-driven system 102.

Defining Moods

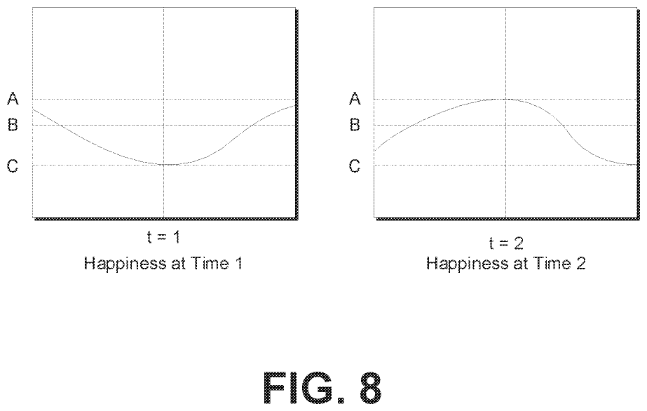

As mentioned above, not only does a disposition-driven system 102 possess a simulated personality that defines the boundaries of the potential responses to stimuli, embodiments provide for a “mood” of the disposition-driven system 102 at the instant of the stimuli to further define the potential responses or subset of responses. As previously discussed, responses or subsets of potential responses to stimuli are selected according to characteristics of a waveform generated by the personality waveform generator 130. The frequency or wavelength of the waveform, and/or the amplitude of the waveform, may determine a first subset of responses within the look-up table 280 from which the disposition-driven system 102 will choose from. According to one embodiment, the specific amplitude of the waveform at the time T at which the stimulus was received may determine a response from the first subset of potential responses, or may further narrow the subset. In these embodiments, the responses or subset of potential responses may correspond with specific values or ranges of values of the amplitude of the wave. Examples are provided and discussed below with respect to FIG. 8. To further narrow the choices to a single response or to a second, smaller subset of potential responses, the mood of the disposition-driven system 102 at the instant of the stimuli may be determined and utilized.

As mentioned above, the disposition-driven system 102 includes or utilizes a mood mechanism 132 to define the boundaries of a simulated mood of the disposition-driven system 102. While a person may have a general personality that guides his or her decisions and actions in life, those same decisions and actions may change at any given time based on his or her mood at that time. As discussed briefly above, a person may react differently to the same stimulus at different times based on his or her mood at the given time. Every individual experiences different moods at different times, including times of the day, days of the week, and seasons of the year. A person's mood may change at an instant according to any external or internal stimulus. The sight of a particularly unpleasant person, object, or situation may tur a person's good mood to a bad mood. Experiencing pain can cause a person's mood to worsen. Conversely, a good experience, or an interaction with another person that is loved or admired, may turn a bad mood to a positive mood. A good or bad surprise can turn a person's mood towards a different direction.

As previously discussed, another distinguishing feature between conventional robots and humans relates to a physiological response to stimuli according to a given mood. Humans experience physiological reactions to their current emotional state. For example, fear, anger, stress, and anxiety may create an increased heart rate, changes in skin conductance, an increase in skin temperature, sweating, an increased breathing rate, and/or cutaneous blood flow causing a skin color change (e.g., blushing). Happiness, sadness, and other emotions may similarly create physiological changes to the human body.

Just as the personality waveform generator 130 creates or utilizes characteristics of a waveform to simulate a human personality that may be used in selecting a response from a first subset of responses to a stimulus, a mood mechanism 132 creates or utilizes a waveform to simulate a human mood that may be used to further select a response from a second subset of responses from the first subset. Moreover, the mood mechanism 132 may trigger or initiate a reaction mechanism 134 or physiological response in the disposition-driven machine 100. In this manner, the mood mechanism 132 creates an appropriate physiological response that corresponds to the particular stimulus, the selected response, and the underlying personality and current mood of the disposition-driven machine 100. In some embodiments, this reaction mechanism 132 may be used to select the action to be taken from the set of responses selected using the waveform from the personality waveform generator 130.

In other words, as an example, the personality waveform characteristics may narrow a total number of potential responses to a set of responses. The characteristics of a mechanical waveform from a vibration generator may determine that the simulated heartbeat of the machine should be raised. The elevated heart rate may then be used to further narrow or select a response from the set of responses chosen from the personality waveform.

As described above, the reaction mechanisms 134 include, but are not limited to, pores 136, color emitting layer 138, conductive coating 140, and heartbeat simulation mechanism 142 to simulate sweating, color changes, electrical or thermal changes, and changes to heart rate, respectively. These reaction mechanisms 134 provide a realistic simulation of human physiological changes that are not found in conventional robots or machines.

According to various embodiments, the mood mechanism 132 includes any type and quantity of known vibration generators that are operatively connected to the disposition-driven system 102 and controllable to vary the frequency and/or amplitude of mechanical vibration corresponding to a mood at any given time. For example, a vibration generator may produce a steady, low frequency and low amplitude mechanical vibration to represent a “good” mood, while a higher frequency and/or higher amplitude mechanical vibration is produced to represent a “bad” mood. Of course, many varying waveform characteristics may be created to represent virtually endless types of moods, but simple terms of “good” and “bad” will be utilized herein for clarity purposes as an example of two differing moods corresponding to two different waveforms.

Exemplary System Modules

As noted above, various aspects of the system's functionality may be executed by certain system modules, including the system's consciousness module 200 and sub-consciousness module 202. The consciousness module 200 is adapted to reaffirm the existence of the system, to translate some stimuli into human language stimuli, and to make conscious response decisions to the human language stimuli, while the sub-consciousness module 202 is adapted to automatically select and execute a response to particular stimuli. The consciousness module 200 and sub-consciousness module 202 may be adapted to work in unison such that the system subconsciously responds to particular stimuli while consciously recognizing its own existence, and to make response decisions after “thinking” about the stimuli and response in a human language. Such an arrangement is adapted to mirror human behavior where a human may act instinctively or subconsciously (e.g., by breathing or walking) as well as intentionally or consciously. These modules are discussed in greater detail below.

Process for Transforming Sensory Input into Action

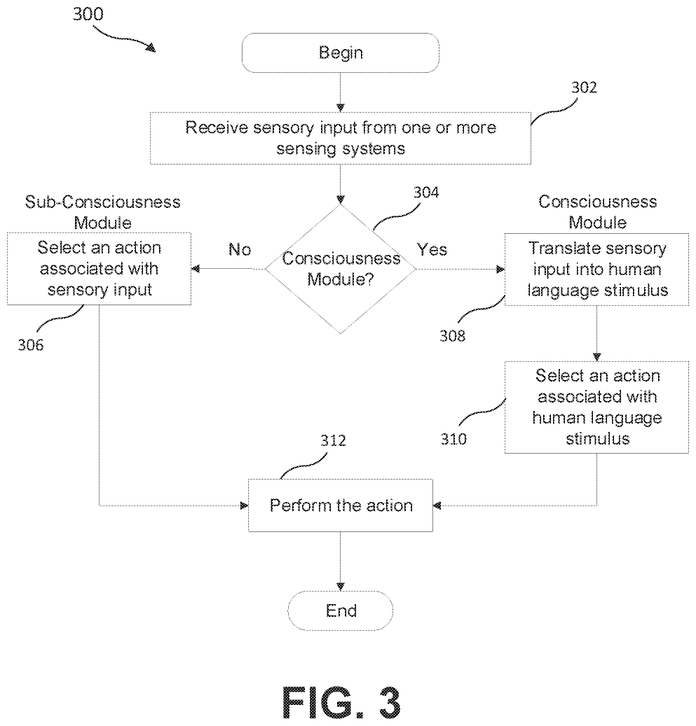

FIG. 3 is a flow chart that generally illustrates a routine 300 for responding to stimuli according to various embodiments described herein. Beginning at operation 302, the system receives sensory input from one or more of the sensors 104. These sensors 104 may include, as shown in FIG. 1, one or more cameras 106, microphones 108, light sensors 110, temperature sensors 112, moisture sensors 114, touch sensors 116, taste sensors 118, olfaction sensors 120, and/or motion sensors 122, and/or any other suitable sensor. At operation 304, a determination is made as to whether the consciousness module 200 or the sub-consciousness module 202 is suitable for directing the response to the sensory input.

With humans, there are many actions that people take without any thought. For example, people walk without thinking about lifting one foot, advancing the foot, planting the foot, then repeating with the opposite foot. When faced with an emergency, people often act without thinking through the stimulus and response. For example, when a ball is thrown to or at a person, the targeted person will catch or dodge the ball without thinking about the action. These actions are all a part of sub-conscious thought. These automatic reactions are processed by the sub-consciousness module of the disposition-driven system 102.

In contrast, there are many stimuli that result in human thought before action. These are the situations in which humans think in their native language before determining how to respond. For example, a person might see a dog and think to themselves in their native language, “that is a cute puppy.” They might then decide to walk over and interact with the animal. Or, depending on their mood, they may simply smile at the scene and decide to continue on their way. This is an example of conscious thought. There is a stimulus, the stimulus is processed and translated into human language, and after thought in the human language, an action is selected and taken. The sub-conscious and conscious response analysis, coupled with the translation of the stimulus into human language during conscious thought, distinguishes the embodiments described herein from traditional robots. Traditional robots are not and would not be configured to translate sensory input into a human language before responding since doing so adds complexity, steps, and time to perform an action based on an input.

The determination at operation 304 as to whether the stimulus will be processed by the sub-consciousness or consciousness module may be determined by reviewing the look-up table 280 for an association of the stimulus with the sub-consciousness or consciousness module. Certain critical or time-sensitive actions will be associated with the sub-consciousness module 202 for immediate action, while a majority of responses will be managed by the consciousness module 200. At operation 304, if the stimulus is to be processed by the sub-consciousness module 202, then the routine proceeds to operation 306, where an action associated with the sensory input is selected from the look-up table 280, and the action is performed at operation 312. However, if at operation 304 it is determined that the stimulus is to be processed by the consciousness module 200, then the routine proceeds to operation 308, where the sensory input is translated into a human language or internal stimulus.

The disposition-driven system 102 is programmed to identify the stimulus and develop a description of the stimulus in a human language. For example, a visual image of an apple might result in a translation of that scene into “there is a green apple on that table.” This translation is performed by the translation module 150. If the translation triggers an action based on stored instructions, then the human language translation is considered a human language stimulus or human language command. However, in one embodiment, the translation triggers further human language thought. In these situations, the translation is considered a human language observation. In this manner, the disposition-driven system 102 engages in thought. The system is thinking in a human language, with each thought becoming an observation that triggers further human language thought, or a trigger or stimulus for an action in response to the human language stimulus. The translation module utilizes stored questions and statements that relate to the received stimuli. For example, the system may be configured to translate the sensory input into one or more questions or statements like “that is (description of the input),” “what is . . . ,” “why is . . . ,” and any other appropriate questions or statements relating to the stimuli. When a question or statement is developed in the human language, the system may utilize past experiences stored in memory to answer the questions developed as observations from the stimuli.

Continuing the example above, after translating the visual scene into “there is a green apple on that table,” based on a past experience, the system may follow up that observation with “John likes apples.” Instructions within the memory or storage then trigger the system to select the action of giving the apple to John. It should be noted that the internal or human language stimulus may be an unspoken human language stimulus that is not spoken or transmitted aloud into audible sound, or it may be a spoken human language stimulus that is actually played aloud via speakers of the disposition-driven system 102. From operation 308, the routine continues to operation 310, where an action associated with the human language stimulus is selected from the look-up table 280, and the action is performed at operation 312. It should be understood that according to various embodiments, the steps of selecting the action (operations 306 and 310) include selecting the proper stored response according to the waveform defining the simulated personality of the system, as well as the mood of the system defined by the mood mechanism 132 at the time of the stimulus, as described in detail above.

Consciousness Module

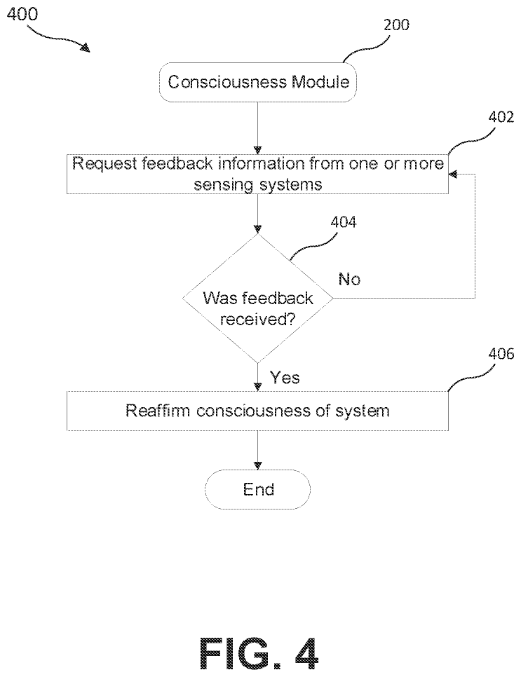

FIG. 4 is a flow chart generally illustrates a routine 400 corresponding to an exemplary consciousness module 200 with respect to the process of reaffirming consciousness. As may be understood from FIG. 4, certain embodiments of the consciousness module 200 are configured to at least substantially continuously (e.g., continuously) confirm the system's existence and to remind the system of its own existence. Beginning at operation 402, the system requests feedback information from one or more of the sensors 104. These sensors 104 may include, as shown in FIG. 1, one or more cameras 106, microphones 108, light sensors 110, temperature sensors 112, moisture sensors 114, touch sensors 116, taste sensors 118, olfaction sensors 120, and/or motion sensors 122, and/or any other suitable sensor. The system then, in operation 404, determines whether feedback was received by the system from any of the one or more sensing systems. Feedback may include, for example, a sound received by the microphone 108 or a touch received by the touch sensor 116. If the system receives no feedback from any of the one or more sensing systems at operation 404, the system returns to operation 402 to request feedback from the one or more sensors 104. If the system does receive feedback at operation 404, the system proceeds to operation 406.

In operation 406, the system, based at least in part on the reception of feedback at operation 404, is able to reaffirm its own existence. The system may reaffirm its own existence, for example, by relaying “I exist” to itself in response to the reception of feedback. By recognizing its own existence as a result of external stimuli that cause the reception of feedback from one or more of its sensing systems, the system is able to continually remind itself of its own existence. By continually reminding itself of its own existence, the system may be able to tell others that it exists, to understand its own existence, or to make it appear as if the system believes its own existence.

In various embodiments of the consciousness module 200, the feedback information requested from the one or more sensing systems at operation 402 may include substantially instantaneous (e.g., instantaneous) feedback information. For example, the system may request feedback from the microphone 108 at the current moment. If the microphone 108 is currently detecting a sound at operation 404, the system will reaffirm its existence at operation 406. In various embodiments of the consciousness module 200, the feedback information requested from the one or more sensing systems at operation 402 may include past feedback information. The system may request, for example, feedback information from a previous date or time (e.g., one week ago, last month, December 15^{th}). For example, the system may request feedback information from the olfaction sensors 120 from two weeks ago. If the olfaction sensors 120 detected an odor two weeks ago at operation 404, the system will reaffirm its existence two weeks ago at operation 406.

In various embodiments of the consciousness module 200, the system establishing and recognizing its own self-consciousness may allow the system to begin to value itself. In this way, the system may have ambitions or take action to preserve or improve itself. It may further be necessary for the system to recall both past and present feedback information for it to become fully self-conscious as humans are.

In various embodiments of the consciousness module 200, the system may be adapted to recognize the end of its own existence. After a certain number of cycles of the system receiving no feedback at operation 404 and returning to operation 402 to request feedback information from the one or more sensing systems, the system may be adapted to recognize that it no longer exists. The certain number of cycles may include: (a) a pre-determined number of cycles; (2) a substantially random (e.g., entirely random) number of cycles; and (3) any other appropriate number of cycles. For example, the certain number of cycles may be determined by the amount of time that the system has existed. For example, a system that has existed for a short time may recognize the end of its existence after a small number of cycles of receiving no feedback from its one or more sensing systems. A system that has existed for a longer period of time may go through more requests for feedback from its one or more sensing systems without receiving feedback before determining that it no longer exists.

Sub-Consciousness Module

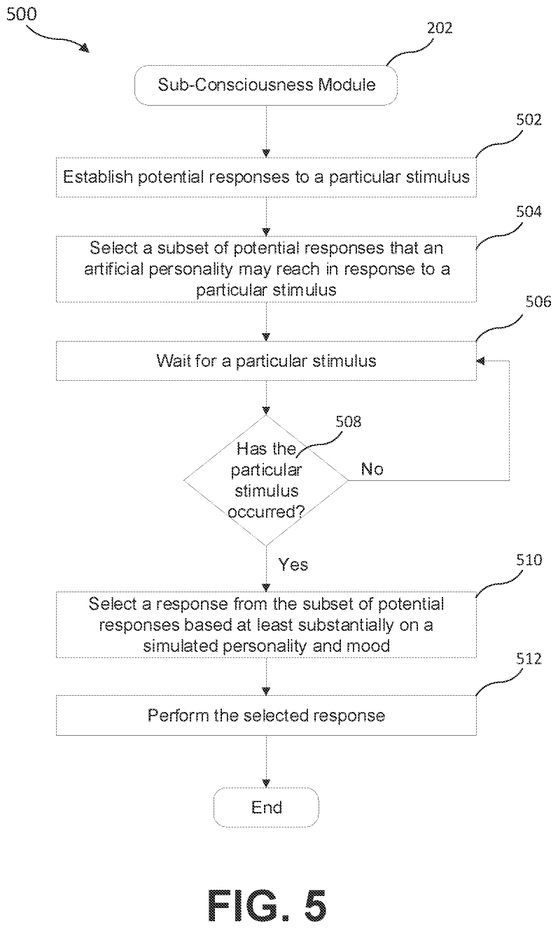

FIG. 5 is a flow chart generally illustrates a routine 500 corresponding to an exemplary sub-consciousness module 202. As may be understood from FIG. 5, certain embodiments of the sub-consciousness module 202 are configured to allow a system to respond sub-consciously to a particular stimulus. For example, the sub-consciousness module 202 may be used to select a response to a person making a threatening gesture. Beginning at operation 502, potential responses to a particular stimulus are established. Then, at operation 504, a subset of potential responses that a simulated personality may reach in response to a particular stimulus is selected from the potential responses established at operation 210. The subset of potential responses in operation 220 may be selected, for example, based on the pre-determined personality of a simulated personality. A system may be programmed to have a particular simulated personality based on the desired personality of the system. For example, if the desired personality of a simulated personality was a non-violent personality, the subset of potential responses at operation 504 would not include any potentially violent responses established at operation 502 in response to a person making a threatening gesture as mentioned above.

The system then, in operation 506, waits for a particular stimulus. The system then checks, in operation 508, whether the particular stimulus has occurred. If the particular stimulus has not occurred, the system returns to operation 506 and continues to wait for a particular stimulus. If a particular stimulus has occurred, the system continues to operation 510.

In operation 510, the system selects a response from the subset of potential response to the particular stimulus that has occurred based at least substantially on its simulated personality. The system then, in operation 512 performs the selected response. It should be appreciated that regardless of the underlying simulated personality or the determined mood at the time of the stimulus, embodiments prevent the system from selecting or performing any action that could cause harm to a person or break an existing law. Harmful actions and applicable legal data may be preprogrammed into memory. For example, should the system receive a violent stimulus such as a push or impact to the machine, even if the underlying simulated personality is grumpy or rude and the current mood corresponds to anger, the machine may react negatively with language or actions to the extent that physically harmful, illegal, or dangerous activities are not performed.

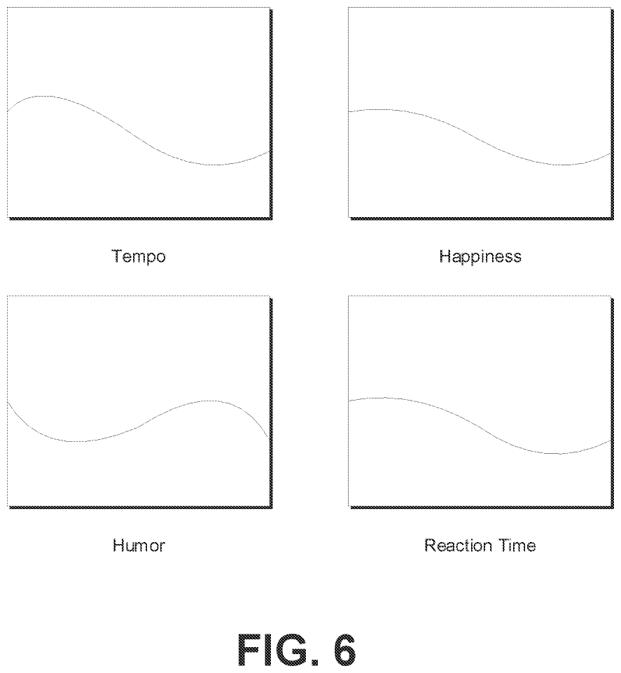

As discussed above, in various embodiments of the disposition-driven system 102, the system's simulated personality may be determined by at least one waveform. FIG. 6 shows four exemplary waveforms that may make up a particular simulated personality. These examples are merely simplified waveform segments shown for illustrative purposes and are not to be considered limiting. As discussed in detail above, the personality waveform generator 130 may provide complex waveforms, characteristics of which are used to select responses or subsets of responses to stimuli. FIG. 6 shows waveforms for the personality traits of tempo, happiness, humor, and reaction time. Various embodiments of a simulated personality may include other personality traits with their own associated waveforms. A waveform associated with a particular personality trait of a simulated personality may be predetermined. For example, a system may be assigned a waveform for humor that has a large amplitude and many fluctuations. Such a system may have the capacity for a more humorous response to a particular stimulus than other systems.

According to various embodiments, the disposition-driven system 102 may utilize any characteristic of the waveform from the personality waveform generator 130 to select a first subset of responses from all potential responses to an external or internal stimuli according to the simulated personality associated with the waveform. For example, the subset of responses may be defined by an amplitude or a frequency of the waveform at the particular time of the stimulus or by an average amplitude or a frequency of the waveform during a particular range of time encompassing the time of the stimulus. According to an alternative example, the characteristic of the waveform may include a color of a light from a light source 92. The light source 92 may be operative to change colors (e.g., via one or more controllable LEDs) according to preprogrammed times or in response to particular stimuli. The disposition-driven system 102 may be operative to detect the color, which corresponds to a simulated personality, or to a simulated mood. In this latter implementation, the mood mechanism 132 may include the light source 92 or an additional light source, which may be used to determine a mood at the time of the stimulus that triggers a response. It should be appreciated that waveforms created by the personality waveform generator 130 and/or the mood mechanism 132 may be pre-programmed, may be randomly generated, may be reactive to the environment (e.g., recognized positive person or object triggers improvement in mood), and/or may be remotely controlled by a user to be altered as desired.

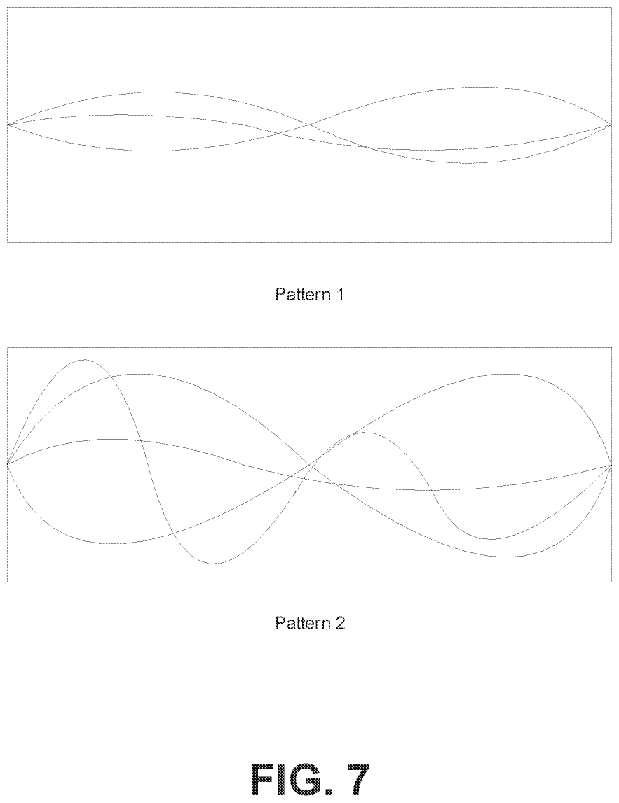

FIG. 7 shows two embodiments of a waveform for a personality trait, or alternatively corresponding to a simulated mood. The waveform of Pattern 1 shows narrow maximum variations. A waveform taking the form of Pattern 1 may express calm, passive attributes of a particular personality trait. Pattern 2 shows a waveform with wide maximums and minimums and a lot of variation. A waveform like Pattern 2 may express an aggressive, active nature of a certain personality trait.

When selecting a response to a particular stimulus at operation 510, the disposition-driven system 102 may be limited in its range of potential responses by the predetermined wave forms associated with its personality traits that make up its simulated personality. The waveforms may define the extremes of potential responses that a system may make to a particular stimulus. A response may then be selected at random within the range of potential responses defined by waveforms of various personality traits.

In various embodiments of the system, as previously discussed, the waveform may be a light waveform. Light waveforms may have an infinite spectrum of colors and wavelengths and a continuous flow. A light waveform may be highly variable and be represented by unlimited numbers of combinations of shapes, speeds, and colors. The light waveform of a simulated personality may be displayed on display device, such as the display device 64 of FIG. 2. In other embodiments, the light waveforms may be stored within a storage device such as the storage device 63 in FIG. 2.

In various embodiments, the system may determine the response by measuring the amplitude of the waveform at the time of a particular stimulus, which may correspond to the mood of the disposition-driven system 102. As may be understood from FIG. 8, the amplitude of a waveform for a particular personality trait may vary at different times. FIG. 8 shows a happiness waveform at two different times: Time 1 and Time 2. As may be understood from FIG. 8, different amplitudes of a waveform may correspond to different potential responses to a particular stimulus. For example, in the happiness waveforms of FIG. 8: (1) Amplitude A may correspond to a potential response including laughter; (2) Amplitude B may correspond to a potential response including a slight smile; and (3) Amplitude C may correspond to a potential response including crying. As shown in FIG. 8, a particular stimulus occurring at Time 1 may result in a response corresponding to Amplitude C. In this example, the response to the particular stimulus at Time 1 would be crying. As shown in FIG. 8, a particular stimulus occurring at Time 2 may result in a response corresponding to Amplitude A. In this example, the response to the particular stimulus at Time 2 would be laughter.

In various embodiments, the system may determine the response by measuring other attributes of the waveform at the time of a particular stimulus or during a range of time encompassing the stimulus. For example, the system may measure the shape of the waveform, or any other suitable attribute of the waveform (e.g., the wavelength or the speed).

In various embodiments of the disposition-driven system 102, the consciousness module 200 and sub-consciousness module 202 may run simultaneously such that the system subconsciously responds to particular stimuli while consciously recognizing its own existence. Such an arrangement is adapted to mirror human behavior where a human may act instinctively or subconsciously (e.g., by breathing or walking) as well as intentionally or consciously.

### First Illustrative Example of a Disposition-Driven System—Consciousness Module

A first illustrated example of the disposition-driven system 102 via the consciousness module 200 of FIG. 4 may include the disposition-driven system as part of a disposition-driven machine. As may be understood from FIG. 1, a disposition-driven machine 100 may further include various sensing systems including one or more cameras 106, microphones 108, light sensors 110, temperature sensors 112, moisture sensors 114, touch sensors 116, taste sensors 118, olfaction sensors 120, and/or motion sensors 122, and/or any other suitable sensor. Other embodiments of a disposition-driven machine 100 that includes the disposition-driven system 102 may include any other suitable sensing systems (e.g., a Pressure Sensor). The disposition-driven system 102 may be adapted to communicate with the various sensing systems to receive feedback information from the various sensing systems.

At operation 402 of the routine 400 corresponding to the consciousness module 200, the disposition-driven machine 100 may request feedback information from one or more of the sensing systems. For example, the disposition-driven machine 100 may request feedback from the one or more cameras 106 and the microphones 108. The disposition-driven machine 100 will then determine, at operation 404, whether any feedback was received from the one or more cameras 106 or the microphones 108. This feedback could come, for example, in the form of movement detected by the cameras 106 or a noise detected by the microphones 108. If the disposition-driven machine receives no feedback at operation 404, it will return to operation 402 to request feedback from the sensing systems again. In requesting feedback from the sensing systems, the disposition-driven machine may request feedback from all systems simultaneously. Alternatively, the disposition-driven machine 100 may request feedback from each sensing system individually. The disposition-driven machine 100 may also request feedback from any combination of available sensing systems at operation 402. The disposition-driven machine 100 may request feedback information from the sensing systems that is instantaneous or from a previous time.

When the disposition-driven machine 100 receives feedback at operation 404, it continues to operation 406 where the disposition-driven machine 100 reaffirms its own existence. The disposition-driven machine may substantially continuously (e.g., continuously) perform the steps of the consciousness module 200 in order to substantially continuously (e.g., continuously) reaffirm its own consciousness. Because it is constantly receiving feedback that indicates that it is interacting with the world around it, the disposition-driven machine 100 is constantly being reminded of its own existence.

By being constantly reminded of its own existence and becoming self-conscious, the disposition-driven machine 100 may be able to recognize and distinguish itself from other elements around it. By realizing its own existence, the disposition-driven machine 100 may recognize what belongs to itself including its physical self as well as its thoughts or feelings. By distinguishing itself from others, the disposition-driven machine may begin to understand and create relationships between itself and others.

### Second Illustrative Example of a Disposition-Driven System—Sub-Consciousness Module

A second illustrated example of the disposition-driven system 102 via the sub-consciousness module of FIG. 5 may include the disposition-driven system 102 as part of a navigation system. A navigation system may include a microphone 108 capable of recognizing and understanding human speech. The navigation system may also include a simulated personality defined by waveforms for various personality traits. For example a navigation system may include a simulated personality that includes a humor waveform that is very volatile and has a large amplitude such as the waveform of Pattern 2 in FIG. 7. The navigation system may further include a simulated personality with a happiness waveform that is passive and weak such as the waveform of Pattern 1 in FIG. 7.

In operation 502 of the sub-consciousness module 202, the navigation system may establish potential responses to a particular stimulus. For example, the navigation system may establish potential responses to being asked for directions to a location. These responses may include a wide variety of responses including providing the proper directions, providing improper directions, or providing no direction at all. The navigation system then, in operation 504, selects a subset of potential responses based on its simulated personality. For example, because this navigation system has a passive and weak happiness waveform, the navigation system may eliminate potential responses from the subset of potential responses that are overly cheerful. A potential response that provides the correct directions and then wishes the person requesting directions a nice day, for example, may not be selected for the subset of potential responses based on the simulated personality described in this example.

The navigation system then, in operation 506, waits for a particular stimulus. In this example, the navigation system waits for someone to ask for directions to a location. When the navigation system determines at operation 508 that someone has asked for directions, it continues to operation 510 and selects a response from the subset of potential responses. The selection of a response at operation 510 may be performed in a substantially random (e.g., random) manner from the subset of potential responses that fit within the simulated personality of the navigation system. For example, because the navigation system has a volatile humor waveform, the response selected at operation 510 may involve providing incorrect directions as a joke.

Further, the subset of potential responses may be further narrowed or filtered according to a simulated mood of the disposition-driven machine 100. The mood may be defined by a frequency or amplitude of a mechanical vibration being created by the mood mechanism 132, which in this example is a vibration generator. The vibration waveform may indicate a particularly bad mood at the moment, which may filter the subset of potential responses to those that are abrupt or even rude. Finally, at operation 512, the navigation system may perform the selected response. In this example, the navigation system would provide the wrong directions provided in a rude manner as a joke, or because of the bad mood, not as a joke. In other embodiments, where the navigation system is programmed to have a volatile temperament or is in a particularly bad mood, the navigation may, for example, refuse to provide directions if its current waveform dictates an unfriendly response. In this manner, the disposition-driven system 102 has reacted to a stimulus according to a mood that the system is currently experiencing, similar to the manner that a typical human reacts to stimuli. Moreover, the mood is physically realized or represented by a physical vibration, which corresponds to and simulates a “feeling” that a human might experience.

### Third Illustrative Example of a Disposition-Driven System—Sub-Consciousness Module

A third illustrated example of the disposition-driven system 102 via the sub-consciousness module of FIG. 5 may include the disposition-driven system 102 as part of a disposition-driven machine 100. The disposition-driven machine 100 may further include various sensing systems including one or more cameras 106, microphones 108, light sensors 110, temperature sensors 112, moisture sensors 114, touch sensors 116, taste sensors 118, olfaction sensors 120, and/or motion sensors 122, and/or any other suitable sensor. Other embodiments of a disposition-driven machine 100 that includes the disposition-driven system 102 may include any other suitable sensing systems (e.g., a Pressure Sensor). The disposition-driven system 102 may be adapted to communicate with the various sensing systems to receive feedback information from the various sensing systems. The disposition-driven machine 100 may also include a simulated personality defined by various personality traits defined by one or more waveforms. In this example, the disposition-driven machine 100 may have a violence waveform that is aggressive and active. The disposition-driven machine 100 may also include a simulated mood defined by one or more waveforms provided by the mood mechanism 132. In this example, at the time of the stimulus, the disposition-driven machine 100 may have a mechanical vibration that has a high amplitude and high frequency corresponding to anger.

In operation 502 of the sub-consciousness module 202, the disposition-driven machine 100 may establish potential responses to a particular stimulus. For example, the disposition-driven machine 100 may establish potential responses to a threat. These responses may include a wide variety of responses including screaming, talking to the source of the threat, and committing a violent act. The disposition-driven machine 100 then, in operation 504, selects a subset of potential responses based on its simulated personality. For example, because this disposition-driven machine has an aggressive, active violence waveform, the disposition-driven machine 100 may include potential responses in the subset of potential responses that are particularly violent. A potential response that includes injuring the source of the threat may be selected for the subset of potential responses based on the simulated personality described in this example.

The disposition-driven machine 100 then, in operation 506, waits for a particular stimulus. In this example, the disposition-driven machine 100 waits for someone to threaten it. When the disposition-driven machine 100 determines at operation 508 that someone has threatened it, it continues to operation 510 and selects a response from the subset of potential responses. The selection of a response at operation 510 may be done in a substantially random manner from the subset of potential responses that fit within the simulated personality of the disposition-driven machine 100. For example, because the disposition-driven machine 100 has an aggressive violence waveform, the subset of responses selected at operation 510 may include aggressive actions, including punching the source of the threat. Further, because the simulated mood in this example, as defined by the mechanical vibration, corresponds to anger, the response selected at operation 510 may be to punch the source of the threat. Finally, at operation 512, the disposition-driven machine may perform the selected response. In this example, the disposition-driven machine 100 would punch the source of the threat.

Disposition-driven machines 100 with other simulated personalities may have a subset of potential responses that differs from the disposition-driven machine in this example. For example, a disposition-driven machine with a calm, passive violence waveform may not include the commission of any violent act in the selection of a subset of potential responses to a threat at operation 504. Such a disposition-driven machine 100 may, when faced with a threat, select a response form a less violent subset of potential responses. A disposition-driven machine 100 with a passive violence waveform may include talking to the source of the threat or reasoning with them in its subset of potential responses. At operation 512, the disposition-driven machine 100 may perform the selected response by talking it out with the source of the threat.

### Fourth Illustrative Example of a Disposition-Driven System—Thinking in Language

In various embodiments, a disposition-driven system 102 may be adapted to think using its voice. In order to more closely recreate human behavior, the system may be adapted to think in some sort of language. Humans, for example, think in their own language and would be unable to understand or known something in a language with which they were not familiar. In various embodiments, a system may say “let me think about that” when determining a response to a particular stimulus. For example, the navigation system of the Second Illustrative Example above may, when asked for directions, say “let me think about it” before determining its response (e.g., providing incorrect directions or not providing any directions). In this way, the system may appear as though it is actually determining responses to various stimuli on its own, rather than based on pre-determined waveforms. The system may even begin to think that it is making these determinations on its own, thereby contributing to its state of self-consciousness.

### ALTERNATIVE EMBODIMENTS

Alternative embodiments of the disposition-driven system 102 may include components that are, in some respects, similar to the various components described above. Distinguishing features of these alternative embodiments are discussed below.

1. Substantially Random Response Selection

In particular embodiments of the sub-consciousness module 202, the response to a particular stimulus at operation 510 may be selected in a substantially random manner (e.g., an entirely random manner). Such selection may occur without consideration of a simulated personality.

2. Other Waveform Embodiments

In particular embodiments, the waveform may include a liquid waveform. The liquid waveform may define a personality trait by its depth, the texture of its surface, or any other suitable characteristic of the liquid waveform. In particular embodiments, the waveform may include a figure waveform. The figure waveform may define a personality trait by its shape, color, surface, or any other suitable characteristic of the figure waveform.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

What is claimed is:

1. A computer-implemented artificial intelligence method for performing an action with a machine, the method comprising:
receiving a first sensory input from one or more sensors of the machine;
determining a stimulus from the first sensory input;
generating a first light or audio waveform created by a personality waveform generator;
generating a second mechanical waveform created by a mood mechanism;
selecting a subset of actions according to the stimulus and according to at least one characteristic of the first light or audio waveform created by the personality waveform generator;
determining a characteristic of the second mechanical waveform;
determining a mood of the machine autilizing the characteristic of the second mechanical waveform;
selecting an action from the subset of actions according to the mood of the machine; and
initiating the action.

2. The computer-implemented method of claim 1, wherein the mood mechanism comprises a vibration generator.

3. The computer-implemented method of claim 2,
wherein the vibration generator is configured to generate a mechanical waveform having a variable frequency,
wherein the second mechanical waveform comprises the mechanical waveform,
wherein the characteristic of the mechanical waveform comprises a frequency of the mechanical waveform at a time of the first sensory input, and
wherein the frequency of the mechanical waveform corresponds to the mood, the mood being one of a plurality of moods associated with a plurality of frequencies.

4. The computer-implemented method of claim 2,
wherein the vibration generator is configured to generate a mechanical waveform having a variable frequency,
wherein the second mechanical waveform comprises the mechanical waveform,
wherein the characteristic of the mechanical waveform comprises an amplitude of the mechanical waveform at a time of the first sensory input, and
wherein the amplitude of the mechanical waveform corresponds to the mood, the mood being one of a plurality of moods associated with a plurality of amplitudes.

5. The computer-implemented method of claim 1, further comprising:
in response to determining the mood of the machine from the characteristic of the second mechanical waveform generated by the mood mechanism, activating a reaction mechanism to produce a physiological response by the machine.

6. The computer-implemented method of claim 5, wherein the reaction mechanism comprises a plurality of pores such that activating the reaction mechanism comprises expelling a liquid from the plurality of pores of the machine to simulate sweating.

7. The computer-implemented method of claim 5, wherein the reaction mechanism comprises a color emitting layer such that activating the reaction mechanism comprises altering a color emitted by the color emitting layer.

8. The computer-implemented method of claim 5, wherein the reaction mechanism comprises a conductive coating such that activating the reaction mechanism comprises transmitting electricity through the conductive coating.

9. The computer-implemented method of claim 8, wherein transmitting electricity through the conductive coating comprises activating a power source and completing a circuit within the coating to increase the temperature of the coating and simulate an increase in skin temperature.

10. The computer-implemented method of claim 8, wherein transmitting electricity through the conductive coating comprises providing an electrical circuit that when touched, provides an electrical shock or stimulation.

11. The computer-implemented method of claim 5, wherein the reaction mechanism comprises a heartbeat simulation mechanism such that activating the reaction mechanism comprises altering a simulated heartbeat of the machine.

12. The computer-implemented method of claim 1, wherein the first light or audio waveform is generated by light.

13. The computer-implemented method of claim 12, wherein the at least one characteristic of the first light or audio waveform created by the personality waveform generator corresponds to a frequency or amplitude of the light wave.

14. The computer-implemented method of claim 1, wherein the first light or audio waveform is generated by sound.

15. The computer-implemented method of claim 1, wherein determining the stimulus from the first sensory input comprises translating the first sensory input into a human language stimulus.

16. A computer-implemented artificial intelligence method for performing an action with a machine, the method comprising:
receiving a sensory input from one or more sensors of the machine;
determining at least one characteristic of a first waveform;
in response to the sensory input, selecting a video corresponding to the sensory input;
selecting a set of actions according to the sensory input, the video, and the at least one characteristic of the first waveform;
determining a characteristic of a mechanical waveform generated by a vibration generator;
activating a reaction mechanism corresponding to the characteristic of the mechanical waveform;
selecting an action from the set of actions according to the characteristic of the mechanical waveform and to the reaction mechanism; and
initiating the action.

17. The computer-implemented method of claim 16, wherein the reaction mechanism comprises a plurality of pores configured to expel a liquid to simulate sweating, a color emitting layer configured to change color to simulate changes to skin color, a conductive coating configured to transmit electricity to simulate changes in temperature, or a heartbeat simulation mechanism configured to alter a simulated heartbeat of the machine.

18. An artificial intelligence system for performing an action with a machine, the system comprising:
one or more sensors;
memory;
at least one processor;
a waveform generator operative to generate a light or audio waveform;
a mood mechanism operative to generate a mechanical waveform;
at least one computer module stored in the memory and coupled to the at least one processor, the at least one computer module operative to
receive a sensory input from the one or more sensors of the machine;
determine at least one characteristic of the light or audio waveform;
in response to the sensory input, select a video corresponding to the sensory input;
select a set of actions according to the sensory input, the video, and the at least one characteristic of the light or audio waveform;
determine a characteristic of the mechanical waveform generated by the mood mechanism;
activate a reaction mechanism corresponding to the characteristic of the mechanical waveform;
select an action from the set of actions according to the characteristic of the mechanical waveform and to the reaction mechanism; and
initiate the action.

19. The system of claim 18, wherein the mood mechanism comprises a vibration generator.

20. The system of claim 18, wherein the reaction mechanism comprises a plurality of pores configured to expel a liquid to simulate sweating, a color emitting layer configured to change color to simulate changes to skin color, a conductive coating configured to transmit electricity to simulate changes in temperature, or a heartbeat simulation mechanism configured to alter a simulated heartbeat of the machine.
